(19) United States
(12) Patent Application Publication
(10) Pub. No.: US 2025/0154310 A1
(43) Pub. Date: May 15, 2025

(54) Polymer Providing Adhesion

(71) Applicant: INTERFACE POLYMERS LIMITED, Loughborough, Leicestershire (GB)

(72) Inventors: Shaun MORRIS, Loughborough, Leicestershire (GB); Alex BIRTLES, Loughborough, Leicestershire (GB); Peter SCOTT, Loughborough, Leicestershire (GB); Christopher KAY, Loughborough, Leicestershire (GB)

(21) Appl. No.: 18/839,536

(22) PCT Filed: Feb. 21, 2023
(86) PCT No.: PCT/EP2023/054339

§ 371 Date: Aug. 19, 2024

(30) Foreign Application Priority Data
Feb. 22, 2022 (GB) 2202427.7

(51) Int. Cl. C08F 297/08; C09D 11/107; C09D 153/00; C09J 153/00

(52) U.S. Cl. CPC C08F 297/083; C09D 11/107; C09D 153/00; C09J 153/00

(57) ABSTRACT

Materials having the following structure (A) wherein R and R¹ may be the same or different and each independently represents an alkyl or aryl group, X may be hydrogen or a C₁ to C₂₀ alkyl group which may be branched or linear and wherein the aromatic ring substituent joined to polymer B is positioned meta or para to the aromatic ring substituent joined to polymer A and, wherein polymer A is a non-polar polymer and polymer B is a polymer formed from at least two polar monomers, the materials are used to improve the adhesion of coatings such as paints, inks and adhesives to polyolefin substrates.

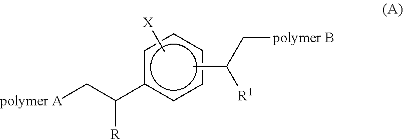

The present invention relates to novel polymers which have improved adhesive properties and in particular which have improved adhesion to olefin polymer and copolymer substrates such as polyethylene and polypropylene and copolymers of ethylene and propylene optionally with other olefinic monomers. The polymers of this invention are particularly useful in improving the adhesion of coatings such as paints, inks, adhesives, sealants, varnishes and primers to the olefin polymers and copolymers.

Polyolefin-based resins such as polypropylene and polyethylene are inexpensive and have various good properties such as good moldability, chemical resistance, water resistance, and electrical characteristics. Such polyolefin-based resins are widely used for substrates such as sheets, films, molded products and the like. However, the polyolefin-based resins are nonpolar (hereinafter, these base materials containing the polyolefin-based resins may be referred to as “polyolefin base materials”) and have a drawback in that their adhesion to polar materials such as those used in coatings such as paints, inks and adhesives is low.

It has been proposed to overcome this problem by modification of the surface of a polyolefin substrate by activation by plasma or gas flame treatment or corona treatment to improve the adhesion properties of the surface. However, these methods are complicated and require large equipment cost and involve time loss. A further drawback is that the effects of the surface treatment can be non-uniform particularly when the shape of the base material is complex and/or due to the influence of a pigment or other additives in the polyolefin substrate, this can become apparent only after the coating such as ink, paint or adhesive has been applied meaning that the part cannot be reworked and must be thrown away creating waste.

Another method of improving the adhesion of olefin polymers or copolymers to polar coatings is the use of a chlorinated polyolefin resin as a primer coating composition to improve the affinity of a polyolefin base material for a polar paint or other polar materials so that the adhesion properties are improved. However, this method has a stability problem due to dehydrochlorination. In addition because of recent increasing environmental awareness, there is a tendency to avoid the use of chlorine.

European Patent 2380917 is concerned with improving the adhesion of coatings to polyolefin substrates and provides an energy ray curable resin composition comprising a block copolymer (C) that includes a polymer block (A) composed mainly of an olefin-based monomer unit and a polymer block (B) composed of a unit derived from (meth)acrylic acid and/or a unit derived from methacrylic ester, the block copolymer (C having a weight average molecular weight of 5,000 or more and 100,000 or less; and an active energy ray curable compound (D) selected from the group consisting of mono(meth)acrylate and poly(meth)acrylate. This technology is also described in a paper by Hideo Hosaka, Yu Takatu, Shuaiji Sekiguchi and Kon-ich-Fujiio entitled “Study on Propylene-Acrylic Block Copolymers as additives in UV Curable Coatings.”

This technology suffers from the disadvantage that it is necessary to employ both a block copolymer and a separate active energy ray curable resin compound in order to get the desired adhesion of the coating to the olefin polymer or copolymer and furthermore it is necessary to irradiate the material once applied to the polyolefin substrate to activate the adhesive properties of the system. Furthermore, the molecular weight of the polymer is controlled by thermal degradation which is not an optimum method for molecular weight control.

We have now found that satisfactory adhesion between coatings and olefin polymer or copolymer substrates can be achieved with certain diblock copolymers which can be applied as an intermediate primer layer to the surface of the olefin polymer or copolymer substrate or can be incorporated as an additive into the coating material. This provides good adhesion whilst requiring less surface preparation than earlier techniques in many instances the substrate can simply be coated and dried to be ready for application of the coating material.

European Patent 2684940 and European Patent 3144330 describe certain block copolymers of formula

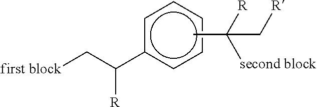

as additives for fuels and oils as well as a process for making such block copolymers and European Patent 3253810 describes the use of such polymers as polymer additives.

We have now found that certain block copolymers having the following structure:

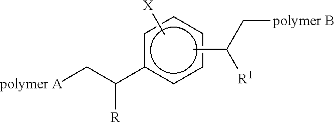

wherein R and R¹ may be the same or different and each independently represents an alkyl or aryl group, X may be hydrogen or C₁ to C₂₀ alkyl group which may be branched or linear and wherein the aromatic ring substituent joined to polymer B is positioned meta or para to the aromatic ring substituent joined to polymer A and, wherein polymer A is a non-polar polymer (or copolymer) and polymer B is a polar copolymer formed from two or more polar monomers are useful in promoting the adhesion between olefin polymer substrates and polar coating materials such as inks and paints. The selection of polymer A and polymer B will depend upon the nature of the olefin polymer and the coating that are to be bonded together.

In a preferred embodiment
i) polymer A comprises a chain of ethylenic or propylenic structural units, optionally copolymerised with higher 1-alkene co-monomers, preferred chains are polyethylene or polypropylene or propylene/ethylene copolymer chains and
ii) polymer B is derived from two or more α,β-unsaturated polar monomers selected from styrene, substituted styrene, unsaturated esters such as acrylate, methacrylate esters such as butyl acrylate, methyl(meth)acrylate, 2-ethyl hexyl methacrylate, glycidyl methacrylate, poly(ethylene glycol) methacrylate, butyl methacrylate, and hydroxyethyl acrylate and vinyl esters, fumarate esters, itaconate esters, maleic anhydride, unsaturated acids such as acrylic acid and methacrylic acid ionomers and diene compounds and derivatives thereof, polymer B may comprise a copolymer of such unsaturated monomers with an alkene such as a C₂ to C₈, preferably a C₂ to C₆ alkene.

These polymers may be prepared by
a) in a first step, polymerising alkenes such as ethylene or propylene, and optionally one or more 1-higher alkene co-monomers, to form polymer A, being a chain consisting of ethylenic or propylenic structural units optionally bearing pendent alkyl groups originating from 1-alkene comonomer(s), the polymerisation reaction being carried out in the presence of a compound of the formula (I):

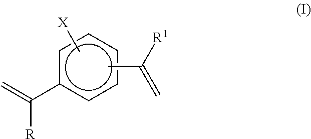

wherein, in the course of the reaction, the compound (I) is terminally incorporated onto polymer A resulting in the formation of a terminally unsaturated intermediate of the formula (II):

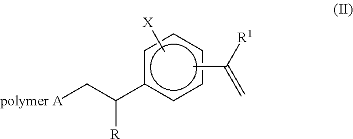

b) in an optional second step, recovering the intermediate (II) from the reaction mixture of the first step; and
c) in a third step, reacting the intermediate (II) at its terminal double bond with a mixture of two or more polar monomers (optionally copolymerized with a non-polar monomer) in a subsequent polymerisation reaction to form polymer B attached to intermediate (II).
   where R, R¹ and X are as previously defined.

Optionally step a) may be performed under hydrogen pressure in order to control the characteristics of polymer A. Step a) employs a catalyst for the polymerisation of the monomer and also the reaction of the polymer with the compound of the formula (I). Any suitable olefine polymerisation catalyst may be used such as traditional Ziegler catalysts, metallocene catalysts being preferred although catalysts referred to in Angie-Chem. Int. Ed 2014 2-25 entitled Post Metallocenes in the Industrial Production of Polyolefins may be used.

In this specification, the word “terminal” when used in relation to a polymer chain (or block) simply refers to the end of the polymer chain (or block), and does not convey any additional mechanistic requirement that the chain (or block) end in question be the end at which the polymerisation reaction terminated. References to “terminally” shall be construed analagously.

It is important that polymer A be terminally joined to polymer B, so as to leave polymer A exposed for interacting with the polymer substrate with which it is used to provide the improved adhesion of the coating to the substrate. As such, it is important that the linkage between polymer A and polymer B be positioned at the end of the polymeric chain of polymer A.

To achieve this terminal positioning of the linkage between polymer A and polymer B, it is essential that the process by which the copolymer is made be specific for terminal functionalization of polymer A. Equally, it is important that the terminal functionalization formed on polymer A be sufficiently reactive to enable the subsequent formation of polymer B typically under radical polymerisation conditions that are industrially practical, whilst at the same time not being so highly reactive that unwanted side reactions occur to a significant extent.

Preferred materials of this invention and for use in this invention are those in which polymer A comprises a chain of ethylenic or propylenic structures or an ethylene/propylene copolymer chain optionally interrupted by one or more structural units derived from higher 1-alkene comonomers such as hexene or octene and polymer B comprises a chain of structural units derived from two or more α,β-unsaturated polar monomers selected from styrene, substituted styrene, unsaturated esters such as acrylate and methacrylate esters, vinyl esters, fumarate esters, itaconate esters, maleic anhydride, unsaturated acids such as acrylic acid and methacrylic acid and diene compounds and derivatives thereof, polymer B may be a copolymer of such monomers with an alkene such as a C₂ to C₈ alkene. In a preferred embodiment polymer B is a copolymer of at least three monomers with at least some of the monomers providing pendant polar groups on polymer B for interaction with the polar groups in the coating materials that are to be bonded to the polyolefin substrate.

The materials used in this invention may be prepared by a process comprising the following steps:
a) in a first step, polymerising an alkene typically ethylene or propylene, and optionally with one or more higher 1-alkene co-monomers, to form polymer A, the reaction being carried out in the presence of a compound of the formula (I):

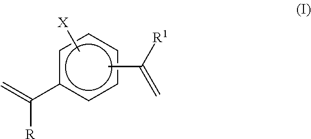

wherein, in the course of the reaction, the compound (I) is terminally incorporated onto polymer A resulting in the formation of a terminally unsaturated intermediate of the formula (II):

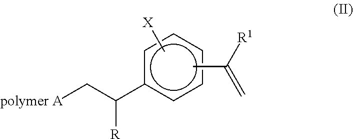

b) optionally, in a second step, recovering the intermediate (II) from the reaction mixture of the first step; and
c) in a third step, reacting the intermediate (II) at its terminal double bond in a subsequent polymerisation reaction with two or more polar monomers to form polymer B.
   wherein R, R¹ and X are as previously defined.

The process aspect of step c) is preferably carried out in the presence of a radical source which initiates polymerisation of the two or more α,β-unsaturated monomers with each other and with intermediate (II). Examples of such monomers include styrene, substituted styrene, unsaturated esters such as acrylate and methacrylate esters, vinyl esters, fumarate esters, itaconate esters including esters containing polar groups such as hydroxyl groups, unsaturated acids such as acrylic acid and methacrylic acid, unsaturated anhydrides such as maleic anhydride and diene compounds and derivatives thereof. As will be known in the art, such a radical source may be a chemical initiator species or it may be an external physical input to the reaction such as light or other radiation source. Preferably the radical source is a chemical initiator species such as a peroxide initiator, an azo-initiator or other such species. Preferred monomers for the production of polymer B include butyl acrylate, methyl acrylate, 2 ethyl hexyl acrylate, glycidyl methacrylate, poly(ethylene glycol) methacrylate, poly(propylene glycol) methacrylate, hydroxy ethyl acrylate, acrylic acid and methacrylic acid maleic anhydride and various ionomers. A preferred material comprises a block copolymer where polymer A is derived from propylene or ethylene optionally with other alkenes and polymer B is a terpolymer of butyl acrylate, acrylic acid and hydroxy ethyl methacrylate.

Accordingly in a preferred embodiment the material used in this invention comprises two polymeric segments A and B wherein:
i) polymer A comprises a chain of ethylenic and/or propylenic structural units, optionally interrupted by one or more structural units derived from higher 1-alkene co-monomers, and
ii) polymer B comprises a chain of structural units derived from two or more α,β-unsaturated monomers selected from styrene, substituted styrene, unsaturated esters such as acrylate, methacrylate, and vinyl esters, fumarate esters, itaconate esters, unsaturated acids such as acrylic acid and methacrylic acid, maleic anhydride and diene compounds and derivatives thereof, polymer B may comprise a copolymer of such unsaturated monomers with an alkene such as C₂ to C₈ preferably C₂ to C₆ alkenes;
   and wherein polymer A and polymer B are terminally joined such that the copolymer has the structure:

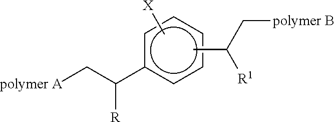

wherein R, R¹ and X are as previously defined and wherein the aromatic ring substituent joined to polymer B is positioned meta or para to the aromatic ring substituent joined to polymer A.

Preferably, each R and R¹ group independently represents an alkyl group having from 1 to 4 carbon atoms. More preferably, R and R¹ are the same and most preferably are both methyl.

Preferably, the aromatic ring substituent joined to polymer B is positioned meta to the aromatic ring substituent joined to polymer A.

Polymer A is selected to be compatible with the olefine polymer or copolymer that provides the substrate to which the coating is to be adhered. We prefer that when the polymer of this invention is to be used with a predominantly polypropylene based substrate polymer A is predominantly comprised of propylene although other comonomers can also be present. Similarly when the polymer is to be used with a predominantly polyethylene based substrate polymer A is preferably predominantly comprised of polyethylene although hereagain other comonomers can also be present. We have generally found that this leads to improved adhesion between the top coating and the substrate.

In another preferred embodiment, polymer A in the material used in this invention consists of a polypropylene chain.

In another preferred embodiment, polymer A in the material used in this invention consists of an ethylene-propylene copolymer.

In another preferred embodiment, polymer A in the material used in this invention consists of an ethylene 1-hexene copolymer.

In another preferred embodiment, polymer A of the material used in this invention consists of an ethylene 1-octene copolymer.

If desired polymer A may after formation be provided with some polarity by the grafting of unsaturated monomers such as maleic anhydride onto polymer A.

When one or more higher 1-alkene monomers are used in conjunction with ethylene or propylene to form polymer A preferably the total proportion of the higher 1-alkene monomers is between 1 and 50 mol %, preferably between 2 and 40 mol %, the remainder of polymer A being derived from ethylene or propylene. When used the amount of the 1-alkene monomer in polymer A preferably ranges from 2 to 15 mole %. A preferred 1-alkene monomer is octene.

Polymer A is preferably produced using a metallocene catalyst and suitable metallocene catalysts for the production of polymer A comprise a transition metal, particularly a metal from group IV of the periodic table such as Ti, Zr or Hf, with one or more ligands such as cyclopentadienyl (“Cp”), substituted cyclopentadienyl (including indenyl, fluorenyl and their derivatives), and bridged variants of the above. Additional ligands may be coordinated or bonded to the metal by heteroatoms such as N, O, S or P and may include bridges to Cp-type ligands as above.

Such catalysts are normally synthesised and stored as a metal dichloride/dialkyl (e.g. dibenzyl) or mono-alkyl-mono-chloride species (“pre-catalyst”). This is activated in solution by addition of a co-catalyst, generally a methylaluminoxane (MAO) or a polymethylaluminoxane (PMAO), but alternatively a non/weakly-coordinating anion may be used such as a combination of a boron containing species such as Ph₃C+B (C₆F₅)₄− and a trialkylaluminium species such as i-(C₄H₉)₃Al.

Examples of such catalysts include Cp₂MCl₂, Cp*₂MCl₂, EBIMCl₂, Flu(Ph₂Me)CpMCl₂, and Cp(Me)₄ (Me₂Si)NtBuMCl₂, wherein M represents a transition metal. Preferred catalysts are catalysts in which M represents zirconium. An example catalyst is Cp₂ZrCl₂ together with a co-catalyst.

The polymer B of this invention is a copolymer of at least two polar monomers wherein at least one of the monomers ensures the dispersion or the solubility of the block copolymer of this invention in the medium in which it is used which may be a solvent or liquid carrier when it is used as a primer coating or may be the solvent or carrier of the coating material when the polymer of this invention is included in the coating material. Polymer B also contains at least one other polar monomer which provides the adhesion between the olefin polymer or copolymer substrate and the coating material to be applied thereto which in the case of paints, inks or adhesives tend to contain polar materials.

We prefer that polymer B is derived from acrylate monomers as these have good reactivity with diisopropyl benzene which is the preferred material for use in the block copolymer manufacture. In particular we have found that using butyl acrylate together with acrylic acid is particularly useful as butyl acrylate provides solubility in solvents such as xylene and acrylic acid provides the polarity required to react with functional groups within the coating materials such as inks and paints.

The preferred make up of polymer A and polymer B will depend upon the substrate with which it is to be used and according to the nature of the top coating to be bonded to the substrate. However when polymer A is largely based on propylene we prefer that it has a number average molecular weight in the range of 3000 to 5000. Where polymer A is largely based on ethylene we prefer that it has a number average molecular weight in the range 1000 to 10,000 preferably 1000 to 2000. The preferred range for the number average molecular weight of polymer B is 500 to 5000. All molecular weights being measured by NMR.

The polymers of this invention may be used as an intermediate primer coating on the substrate for the adhesion of a top coating to the substrate. Alternatively the polymers may be incorporated in the top coating. As a further or less preferred alternative the polymer of the invention may be included in the substrate. Where the polymer is applied to the polyolefin substrate as a primer coating it is preferably applied as a solution or a suspension of the polymer and is dried after application before application of the top coat. The liquid used to produce the solution or suspension depends on the conditions to be employed however organic solvents such as xylene and butyl alcohol may be used as can water when the polymer is to be applied as a suspension; surfactants may be included as necessary. Mixtures of solvents such as mixtures of organic solvents such as butyl acrylate and water may also be used.

Similarly when the polymer is to be included in the top coating and the top coating is to be applied as a liquid the polymer should be soluble or dispersible in the liquid medium employed in the top coating. If the top coating is to be applied as a melt then the polymer of the invention should be miscible or soluble in the molten top coating at the time of application.

Examples of top coatings with which this invention is useful include paints such as automotive paints which may be water based or solvent based. Typical paints include 2K paints such as 2K polyurethane paints, acrylic paints, spray paints. Other coatings are inks such as the typical commercial inks including solvent based inks. The invention may also be used to secure adhesives including most typical commercial adhesives and other coatings such as varnishes to polyolefin substrates.

The polymers of this invention have been found to be useful in promoting the adhesion of coatings to a variety of substrates. For example the substrate may include moulded and extruded articles including films and heavy duty sheeting; components of various types for example for automobiles and domestic appliances. The substrates may be filled with for example reinforcing fibres such as glass or carbon fibre. The substrates may also contain other conventional additives.

The following Example 1 illustrates the preparation of materials in which polymer A is polypropylene that may be used in this invention.

### Preparation of a Polypropylene, 1,3 Disopropylbenzene Intermediate

The catalyst used was a mixture of a 30 wt % solution of polymethyl aluminoxane in toluene and racemic-ethylene bis(1-indenyl) zirconium dichloride.

0.013 kg of the solution of polymethyl aluminoxane; 0.014 g of the zirconium dichloride 0.216 grams of hydrogen, 0.316 litres of meta diisopropylidene benzene, 1.391 kilograms of propylene at 0.685 litres of toluene and were introduced into an agitated pressure reactor.

The vessel was pressurised with nitrogen and heated to 60° C. The toluene, the diisopropylidene benzene and the catalyst were first charged to the reactor which was agitated at 850 rpm. The propylene was then fed to the reactor together with the hydrogen. The temperature of the reaction was monitored and when the exotherm peak is reached the temperature was maintained at between 7° and 75° C. until the catalyst consumption was complete.

The reactor was then vented and the contents drained and allowed to cool; 7 litres of methanol were added to dissolve the polymer. Finally the sample was filtered, washed with methanol and dried at 85° C. in a vacuum for 3 days.

On analysis the polymer had an Mn of 4400 g/mol and an Mw of 9400 g/mol.

The confirmation of the desired terminal functionalisation structure is obtained by nuclear magnetic resonance spectroscopy.

For example, NMR spectra can be recorded on Bruker DPX400 and DPX500 spectrometers, wherein ¹H and ¹³C NMR spectra are referenced internally using the solvent resonances relative to tetramethylsilane. Routine NMR assignments (including polymer samples) can be confirmed by ¹H-¹H (COSY), ¹³C-¹H (HMQC) and ¹³C-¹H (HMBC) correlation experiments where necessary.

In particular, to confirm the terminal insertion of the compound (I), ¹H NMR spectroscopy can be employed. Determination of the amount of terminal insertion is achieved by comparison of the spectroscopic peaks for a methyl group at one end of the polyethylene chain which has three protons and a single proton on the benzylic carbon of the 1,3-DIB molecule remaining after step a) of the reaction. Any 1,3-DIB incorporated in-chain would not have a proton on this carbon, and thus this proton resonance serves to distinguish terminal insertion of the 1,3-DIB.

The ¹H NMR peaks associated with these protons have chemical shifts of 0.91 ppm and 2.71 ppm respectively (chemical shifts are measured against the residual solvent signal in d₂-TCE at 5.94 ppm). Comparing the integrals of these two peaks gives the amount of terminal insertion by 1,3-DIB and indicated that essentially each polypropylene chain is terminally functionalised by the residue from the 1,3-DIB.

The third step c) of the process involves the formation of polymer B by way of a radical polymerisation. The following examples show how this may be done.

The polypropylene diisopropyl benzene material so produced was then used as a starting material for the production of the polypropylene-di-isopropyl benzene-block (butyl acrylate/acrylic acid/hydroxyethyl methacrylate) copolymer of this invention as follows.

2.42 grams of benzoyl peroxide initiator were dissolved in 20 ml of xylene in a vessel and then purged with nitrogen. 15 grams of the polypropylene diisopropyl benzene and 150 ml of xylene were charged to a separate vessel; acrylic acid and 12.31 ml of hydroxyethyl methacrylate were charged to a third vessel equipped with an air purge. The polypropylene diisopropyl benzene was placed in the reactor and heated to 125° C. with mechanical stirring while being purged with nitrogen. The acrylic monomer mixture and the initiator were then fed into the reactor while maintaining the reactor at 125-130° C. over a period of about one hour and the reaction product was obtained in the form of a polymer dispersion in xylene.

The final polymer was found to have a Mw of about 1200 g/mol and initial analysis of the polar block suggests that the ratio of monomer units was 13 butyl acrylate: 5 acrylic acid: 5 hydroxyethyl methacrylate and a molecular weight (Mw) of 2,700 g/mol.

In one run the homopolymer that is also formed together with any unreacted monomers were removed. In a second run the homopolymers and unreacted monomer were left in the product.

### EXAMPLE 2

A product comprising polyethylene/diisopropyl benzene/poly(Butyl acrylate/acrylic acid/hydroxyethyl methacrylate copolymer) was produced in a similar manner to the product of Example 1 except ethylene was used in place of propylene as the feed for the first stage of manufacture to produce a polyethylene/diisopropyl benzene polymer of Mn 1300 g/mol and Mw of 4,200 g/mol.

Initial analysis of the polar block of the product suggested a ratio of 3 butyl acrylate: 2 acrylic acid: 2 hydroxy ethyl methacrylate monomer units and an Mw of 800 g/mol giving an Mw of the final product of about 5000 g/mol.

In both Examples the molecular weights were determined by high temperature GPC in TCB at 160° C.

An important use according to the polymers of this invention is to provide interfacial activity such as that required in providing a printable or a paintable surface on polyolefin substrates, such as for packaging films, sacks, refuse disposal bags, automotive parts such as bumpers, etc., a material in which polymer A is a polyalkene such as polyethylene or poplypropylene and polymer B is of polar monomers that react with polar compounds in the coating material such as paint or ink to get the desired adhesion such as vinyl acetate, acrylates such as methyl acrylate and butyl acrylate or itaconate esters can be used. Examples of preferred monomers for the production of polymer B are acrylates, substituted acrylates and unsaturated carboxylic acids.

### EXAMPLE 3

Example 1 was repeated except that 0.85 mole % of octene-1 was included in the propylene to produce a polymer in which polymer A was an propylene/octene-1 copolymer.

The products of Example 1, 2 and 3 were tested as a coating on polypropylene and on polyethylene to determine their adhesive properties and they were found to have good adhesion to plaques of polyethylene and polypropylene and also on biaxially oriented polypropylene film. The adhesion was found to be good.

A dispersion of the material of Example 1 in xylene was tested as primer coatings on polypropylene and propylene copolymer substrates to determine their ability to bond inks, automotive paints and adhesives including epoxy and urethane based adhesives as well as 2 KPU varnish to the substrates. The adhesion was found to be good.

The dispersion of Example 2 in xylene was tested as a primer coating on polyethylene and ethylene copolymer substrates to determine their ability to bond inks, automotive paints and 2 KPU varnish to the substrates and the adhesion was found to be good

Adhesion was tested according to ASTM-D3359 test method B (the Cross Cut Tape Test) using Tesa 25 mn 4651 tape and a BYK Cross Cut Knife II blade 1-edge 1.5 mn (5127).

The products of both runs of Example 1 were also used as additives in inks and automotive paint at various concentrations and the adhesion of the inks and paints to a propylene copolymer substrate were determined, and good adhesion was achieved with these blends.

1. A block copolymer having the following structure: 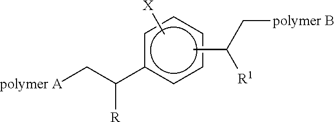
wherein R and R¹ may be the same or different and each independently represents an alkyl or aryl group, X may be hydrogen or C₁ to C₂₀ alkyl group which may be branched or linear and wherein the aromatic ring substituent joined to polymer B is positioned meta or para to the aromatic ring substituent joined to polymer A and, wherein polymer A is a non-polar polymer or copolymer and polymer B is a polar copolymer formed from two or more polar monomers.

2. The block copolymer according to claim 1, wherein:
i) polymer A comprises a chain of ethylenic or propylenic structural units, optionally copolymerised with higher 1-alkene co-monomers, and
ii) polymer B is derived from two or more α,β-unsaturated polar monomers selected from styrene, substituted styrene, unsaturated esters such as acrylate, methacrylate esters and vinyl esters, fumarate esters, itaconate esters, maleic anhydride, unsaturated acids such as acrylic acid and methacrylic acid, ionomers and diene compounds and derivatives thereof.

3. The block copolymer according to claim 1, wherein polymer B comprises a copolymer of the unsaturated monomers with a C2 to C8 alkene.

4. The block copolymer according to claim 1, in which polymer B is a copolymer of at least three monomers with at least some of the monomers providing pendant polar groups on polymer B.

5. (canceled)

6. The block copolymer according to claim 1, wherein one of the monomers in polymer B is butyl acrylate.

7. The block copolymer according to claim 1, in which polymer B is a terpolymer of butyl acrylate; acrylic acid and hydroxyethyl methacrylate.

8. The block copolymer according to claim 1 in which polymer A is polypropylene or a propylene containing polymer and is of number average molecular weight in the range of 3000 to 5000.

9. The block copolymer according to claim 1, in which polymer A is polyethylene or an ethylene containing polymer and is of number average molecular weight in the range of 1000 to 10,000.

10. The block copolymer according to claim 1, in which polymer B has a number average molecular weight in the range of 500 to 5000.

11. A solution of the block copolymer according to

12. A dispersion of «the block copolymer according to claim 1.

13.-21. (canceled)

22. An ink containing the block copolymer according to claim 1.

23. A paint containing the block copolymer according to any claims 1.

24. An adhesive containing the block copolymer according to claim 1.

25. A process for the preparation of a block copolymer according to comprising the following steps:
a) in a first step, polymerising an alkene typically ethylene or propylene, and optionally with one or more higher 1-alkene co-monomers, to form polymer A, the reaction being carried out in the presence of a compound of the formula (I): 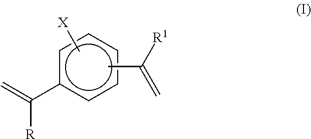
wherein, in the course of the reaction, the compound (I) is terminally incorporated onto polymer A resulting in the formation of a terminally unsaturated intermediate of the formula (II): 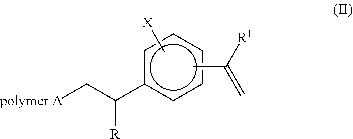
b) optionally, in a second step, recovering the intermediate (II) from the reaction mixture of the first step; and
c) in a third step, reacting the intermediate (II) at its terminal double bond in a subsequent polymerisation reaction with two or more polar monomers to form polymer B:
wherein R, R¹ and X are as previously defined.

26. The process according to claim 25 in which step c) is carried out in the presence of a radical source which initiates polymerisation of the two or more α,β-unsaturated monomers with each other and with intermediate (II).
